(19) United States
(12) Patent Application Publication
(10) Pub. No.: US 2025/0319845 A1
(43) Pub. Date: Oct. 16, 2025

(54) WIPER SYSTEM AND METHOD

(71) Applicant: GM Global Technology Operations LLC, Detroit, MI (US)

(72) Inventor: James Hingst, Canton, MI (US)

(73) Assignee: GM Global Technology Operations LLC, Detroit, MI (US)

(21) Appl. No.: 18/633,999

(22) Filed: Apr. 12, 2024

(51) Int. Cl. B60S 1/08

(52) U.S. Cl. CPC B60S 1/0896; B60S 1/0807

(57) ABSTRACT

A computer-implemented method causes data processing hardware to perform operations including, based on adjustment of a power mode of a vehicle from an ON state to an OFF state, and based on a current operation mode of a wiper system of the vehicle including an active state, storing the current operation mode of the wiper system. The operations also include, based on the stored current operation mode including the active state, and responsive to adjustment of the power mode of the vehicle from the OFF state to the ON state, operating the wiper system in an inactive state and generating a notification to a vehicle user. Furthermore, the operations include, based on the stored current operation mode being the active state, and responsive to passage of a threshold period of time after generating the notification to the vehicle user, operating the wiper system in the active state.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a wiper system of a vehicle.

Wiper systems typically include a pair of front wiper blades associated with a windshield of a vehicle and, depending on the particular type of vehicle, a rear wiper blade associated with a rear window of the vehicle. The front wiper blades and the rear wiper blade generally include a strip of rubber that interacts with the windshield in the case of the front wiper blades or the rear window in the case of the rear wiper blade. The strip of rubber is supported by an arm that is movable relative to the windshield or the rear window by a motor to selectively sweep the strip of rubber across the windshield and rear window. As the strip of rubber sweeps across the windshield or rear window, the rubber removes precipitation such as rain, snow, and ice, as well as dirt, leaves, and other debris from the windshield and rear window, thereby improving visibility for the vehicle occupant.

Conventional wiper systems may be controlled by a vehicle occupant via a stalk having a series of controls. The stalk may extend from a steering column of the vehicle to provide easy and quick access to the controls of the wiper system. The controls may allow the occupant to move the wiper system from a rest state to an actuated state and, further, may allow the occupant to control the speed with which the front wipers and rear wiper sweep across the windshield and rear window, respectively. Further, most modern vehicles allow the occupant to operate the wiper system in an automatic mode, which relies on one or more sensors to detect whether the wiper system should be moved from the rest state to the actuated state and, if so, how fast the wipers should sweep across the windshield and rear window. The one or more sensors may sense the amount of precipitation on the windshield and rear window and may control the wipers accordingly.

While conventional wiper systems adequately clear precipitation and debris from vehicle windshields and rear windows and, further, provide an occupant with the ability to control operation of the wiper systems, conventional wiper systems are often inadvertently set to an actuated state in dry conditions. For example, an occupant may utilize a wiper system in rainy conditions but may forget to turn off the wiper system once the rain has stopped or upon exiting the vehicle. In such circumstances, the front wipers and/or rear wiper may sweep across a dry surface, thereby causing undesirable noise and potentially causing harm to the rubber strip associated with the front wipers or the rear wiper. Furthermore, if an occupant forgets to turn off the wiper system upon exiting the vehicle during wintery conditions, and snow and ice accumulate on the windshield, the front wipers and/or rear wipers may sweep across a snowy and icy surface that may include jagged and sharp pieces of ice, which may also potentially cause harm to the rubber strip associated with the front wipers or the rear wiper. Accordingly, a need exists to mitigate inadvertent use of a wiper system in circumstances when the wiper system is unnecessary or when operation of the wiper system may cause damage to one or more of the front wipers and the rear wiper.

### SUMMARY

One aspect of the disclosure provides a computer-implemented method. When the method is executed on data processing hardware, it causes the data processing hardware to perform operations. The operations include, based on adjustment of a power mode of a vehicle from an ON state to an OFF state, and based on a current operation mode of a wiper system of the vehicle including an active state, storing the current operation mode of the wiper system. Furthermore, the operations include, based on the stored current operation mode including the active state, and responsive to adjustment of the power mode of the vehicle from the OFF state to the ON state, operating the wiper system in an inactive state and generating a notification to an occupant of the vehicle. The operations further include, based on the stored current operation mode being the active state, and responsive to passage of a threshold period of time after generating the notification to the occupant of the vehicle, operating the wiper system in the active state.

Implementations of the disclosure may include one or more of the following optional features. In some examples, the notification includes a visual notification at a display of the vehicle. In some further examples, the visual notification includes a countdown timer generated based on the threshold period of time.

In some implementations, the method includes, based on the stored current operation mode being the active state, before passage of the threshold period of time, and responsive to a mode selector of the vehicle being adjusted from a park mode to a propulsion mode, operating the wiper system in the active state.

In some aspects, the method includes, based on the stored current operation mode being the active state, before passage of the threshold period of time, and responsive to a user input, operating the wiper system in the active state. In some further aspects, the user input includes an input at a wiper mode selector. In some other further aspects, the user input includes acknowledgement of the notification.

In some examples, the method includes, based on adjustment of the power mode of the vehicle from the OFF state to the ON state during a remote start operation, generating the notification to the occupant of the vehicle responsive to determining presence of the occupant in the vehicle.

In some implementations, the wiper system includes a front wiper.

In some aspects, the wiper system includes a rear wiper.

Another aspect of the disclosure provides a wiper system configured to execute a computer-implemented method on data processing hardware that causes the data processing hardware to perform operations. The operations include, based on adjustment of a power mode of a vehicle from an ON state to an OFF state, and based on a current operation mode of the wiper system of the vehicle including an active state, storing the current operation mode of the wiper system. Furthermore, the operations include, based on the stored current operation mode including the active state, and responsive to adjustment of the power mode of the vehicle from the OFF state to the ON state, operating the wiper system in an inactive state and generating a notification to an occupant of the vehicle. The operations further include, based on the stored current operation mode being the active state, and responsive to passage of a threshold period of time after generating the notification to the occupant of the vehicle, operating the wiper system in the active state.

Implementations of this aspect of the disclosure may include one or more of the following optional features. In some examples, the wiper system operates in the active state based on the stored current operation mode being the active state and responsive to a mode selector of the vehicle being adjusted from a park mode to a propulsion mode before passage of the threshold period of time.

In some implementations, responsive to a user input, the wiper system operates in the active state based on the stored current operation mode being the active state and before passage of the threshold period of time. In some further implementations, the user input includes an input at a wiper mode selector. In some other further implementations, the user input includes acknowledgement of the notification.

Yet another aspect of the disclosure provides a vehicle. The vehicle includes a wiper system configured to execute a computer-implemented method on data processing hardware that causes the data processing hardware to perform operations. The operations include, based on adjustment of a power mode of the vehicle from an ON state to an OFF state, and based on a current operation mode of the wiper system of the vehicle including an active state, storing the current operation mode of the wiper system. Furthermore, the operations include, based on the stored current operation mode including the active state, and responsive to adjustment of the power mode of the vehicle from the OFF state to the ON state, operating the wiper system in an inactive state and generating a notification to an occupant of the vehicle. The operations further include, based on the stored current operation mode being the active state, and responsive to passage of a threshold period of time after generating the notification to the occupant of the vehicle, operating the wiper system in the active state.

Implementations of this aspect of the disclosure may include one or more of the following optional features. In some examples, the wiper system operates in the active state based on the stored current operation mode being the active state and responsive to a mode selector of the vehicle being adjusted from a park mode to a propulsion mode before passage of the threshold period of time.

In some implementations, responsive to a user input, the wiper system operates in the active state based on the stored current operation mode being the active state and before passage of the threshold period of time. In some further implementations, the user input includes an input at a wiper mode selector. In some other further implementations, the user input includes acknowledgement of the notification.

### BRIEF DESCRIPTION OF THE DRAWINGS

The drawings described herein are for illustrative purposes only of selected configurations and are not intended to limit the scope of the present disclosure.

FIG. 1 is a side-view of a vehicle including a wiper system in accordance with the principals of the present disclosure.

FIG. 2 is a top-view of the vehicle shown in FIG. 1 with the wiper system including windshield wipers disposed at a front windshield of the vehicle and a rear wiper associated with a rear window of the vehicle.

FIG. 3 is a perspective view of an interior of the vehicle shown in FIG. 1, including a user control of the wiper system and a display.

FIG. 4 is a displayed notification of the wiper system being in an active state.

FIG. 5 is a flow-chart detailing operation of the wiper system of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

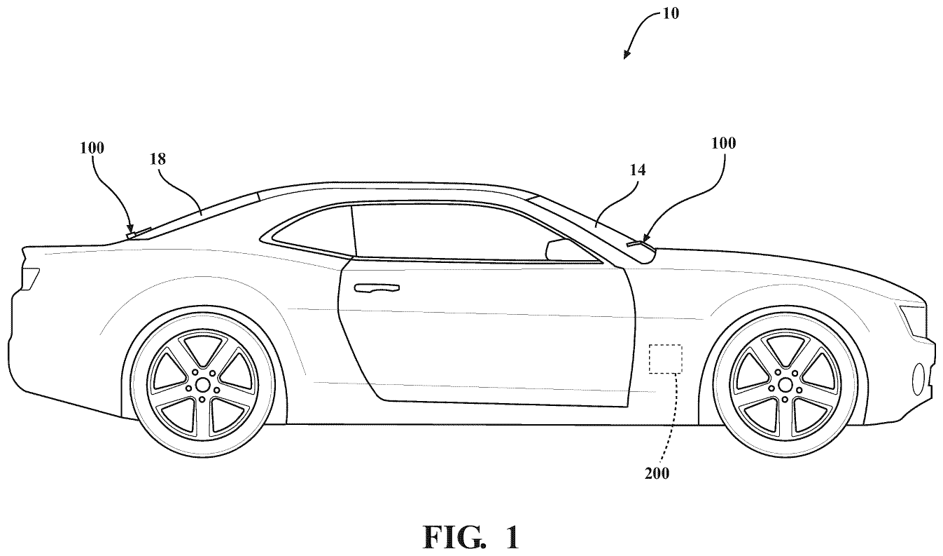

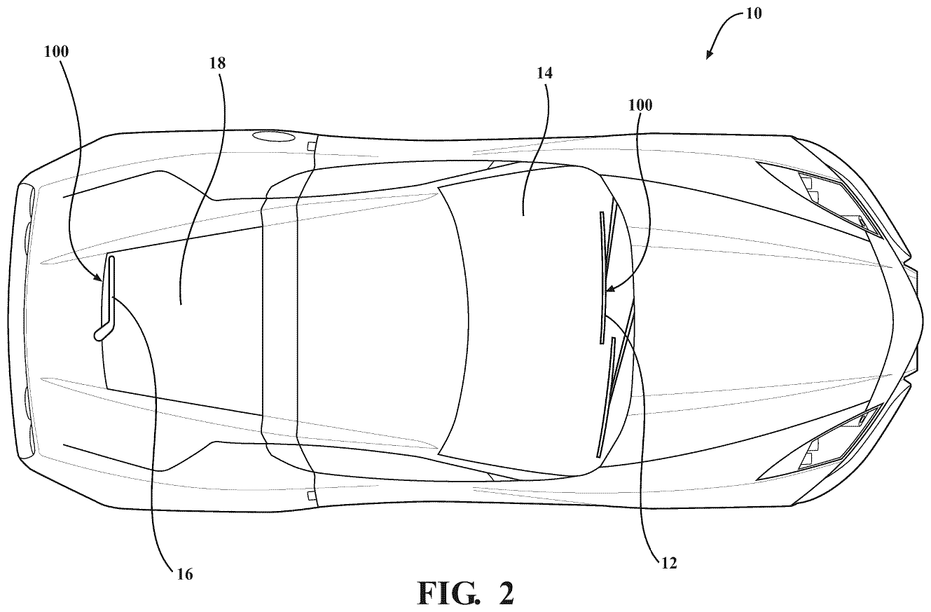

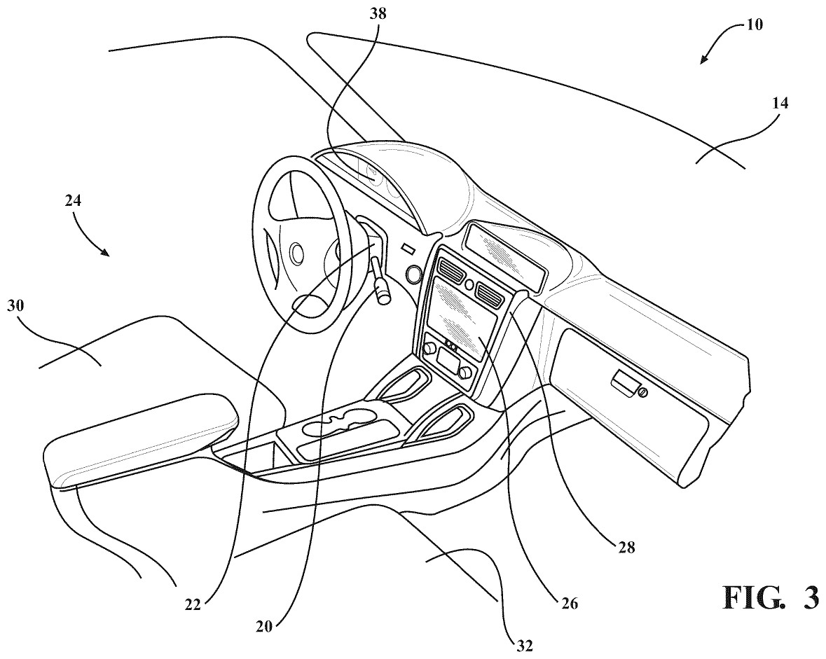

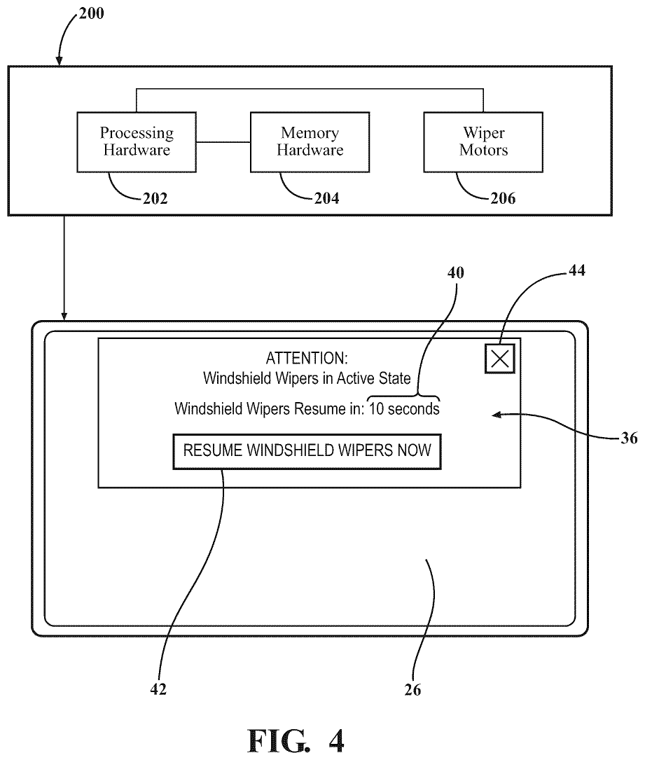

With reference to FIGS. 1-3, a vehicle 10 includes a wiper system 100 having multiple wipers including a pair of front wipers 12 disposed at a front windshield 14 of the vehicle 10 and a rear wiper 16 disposed at a rear window 18 of the vehicle. For illustrative purposes, the vehicle 10 includes a total of three (3) wipers. However, the vehicle 10 could include fewer or more wipers depending on the particular configuration of the vehicle 10. For example, a sedan may only include two (2) wipers associated with a windshield while a sport utility vehicle (SUV) may include three (3) wipers; two (2) associated with a windshield and one (1) associated with a rear window of the SUV. The windshield wipers 12, 16 function based on an input from a user or vehicle occupant at a user control 20 of a wiper control system 200 (FIG. 4). As shown in FIG. 3, the user control 20 for the wiper control system 200 is disposed at a steering column 22 of an interior cabin 24 of the vehicle 10. While the user control 20 is shown as a stalk in the illustration, the user control may be configured differently, depending on the specific interior design of the vehicle 10, without deviating from the scope of the present disclosure. Additionally, the interior cabin 24 includes a display screen 26, such as a digital display, located at a center stack 28 of the vehicle 10 between a driver seat 30 and a passenger seat 32.

In operation, an occupant will position the user control 20 from an inactive state to one of multiple active states to control the function of the front wipers 12, and/or the rear wiper 16 depending on driving conditions. For example, an occupant may activate one or more of the wipers 12, 16 into an active state during rainy or snowy conditions. Movement of the wipers 12, 16 from the rest state to an active state may be accomplished by twisting a knob on the user control 20, sliding a button on the user control 20, moving the user control 20 up or down, or any type of manipulation as required by the specific user control 20 to activate one or more of the wipers 12, 16. When the wiper system 100 is in the inactive state, the wipers 12, 16 do not function and remain in a resting position that does not obstruct the occupant's view out of the front windshield 14 or the rear window 18. When the wiper system 100 is in the active state, the wipers 12, 16 actively function by sweeping across either the front windshield 14, the rear window 18, or both, depending on the specific active state. The multiple active states are present to allow the occupant to activate either the front wipers 12, the rear wiper 16, or both simultaneously and, further, to control the frequency and speed of wiper operation. As an example, one active state may intermittently sweep the wipers 12 across the front windshield 14 every ten (10) seconds. A different active state may sweep the front wipers 12 across the windshield every five (5) seconds. An even different active state may sweep the front wipers 12 across the windshield 14 continuously at a slow speed, while another active state may sweep the front wipers 12 across the windshield 14 continuously at a fast speed. Regardless of the specific active state of the wiper system 100, it should be noted that each active state commands one or both wipers 12, 16 to move at a calibrated frequency and a calibrated speed, thereby controlling how frequent and at what speed the wipers 12, 16 traverse the windshield 14 and rear window 18, respectively.

The user control 20 may be positioned such that one or both of the wipers 12, 16 is in an active state whether the vehicle 10 is in an ON state or an OFF state. For example, an occupant may apply an upward force on the user control 20 to move at least one of the wipers 12, 16 into the active state. When the vehicle 10 is in the ON state, this will cause the at least one wiper 12, 16 to sweep across the windshield 14 or rear window 18 depending on the specific command provided to the user control 20. If the vehicle 10 is in the OFF state, moving the user control 20 into a position that would cause one or both of the wipers 12, 16 to move into the active state will not cause movement of either wiper 12, 16. However, if the user control 20 is in the upward position, in this example, and the vehicle 10 is moved into the ON state, one or both of the wipers 12, 16 will be moved across the windshield 14 or rear window 18, respectively once the vehicle 10 is activated. In so doing, the wipers 12, 16 may traverse across a dry surface, thereby causing unnecessary wear on the wiper 12, 16.

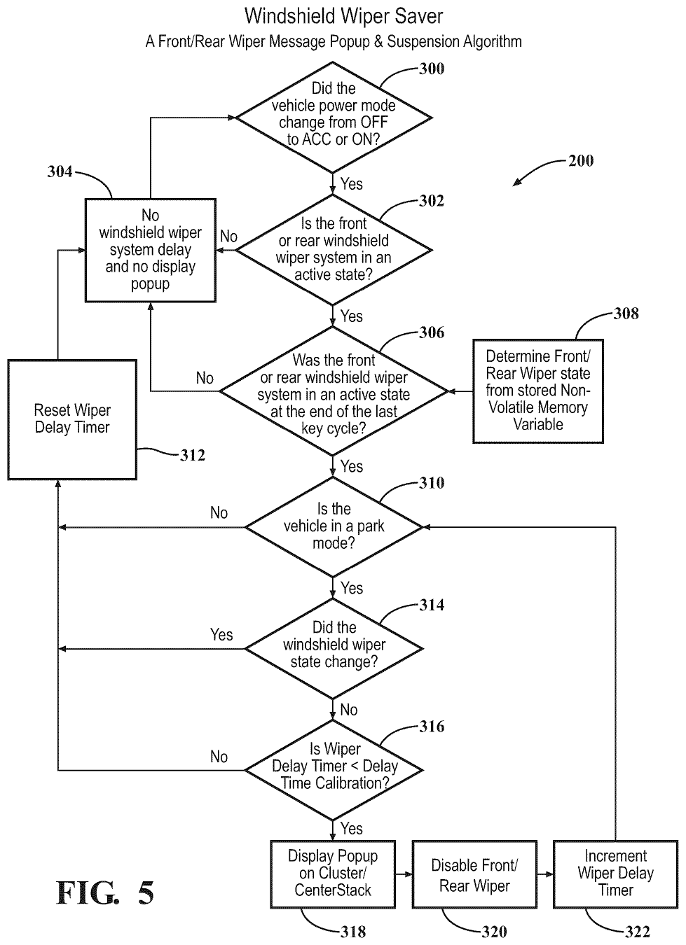

With reference now to FIGS. 4 and 5, the wiper control system 200 is shown as including processing hardware 202 and memory hardware 204 in communication with the display screen 26 and one or more wiper motors 206 respectively associated with the front wipers 12 and the rear wiper 16. As will be described, the memory hardware 204 stores instructions that when executed by the processing hardware 202 cause the processing hardware 202 to perform the functions set forth in FIG. 5. The processing hardware 202 and memory hardware 204 may be incorporated into a standalone controller or, alternatively, may be incorporated into a vehicle controller such as, for example, a body control module (BCM)(not shown). The wiper control system 200 is in communication with the wiper system 100 and provides the occupant with a notification, such as a visual notice 36 on the display screen 26 upon vehicle start-up (i.e., when the vehicle 10 is moved into the ON state) that the wiper system 100 has been retained in an active state when the vehicle 10 was previously placed into the OFF state. The wiper control system 200 will not activate the wipers 12, 16 via the wiper motors 206 if the vehicle 10 is moved into the ON state from the OFF state even if the user control 20 is in an active position. Deactivating the wiper motors 206 in this instance is performed along with the visual notice 36 on the display screen 26. Accordingly, the wipers 12, 16 will not sweep across the windshield 14 or the rear window 18, respectively, while the wiper control system 200 is active even if the user control 20 is in a position that would otherwise cause movement of one or both of the wipers 12, 16. While the notification described herein comprises a visual indication, it can be appreciated that the notification may be of any variety such as audible, haptic, or visual, as non-exhaustive examples, that performs the function of informing the occupant that the wiper system 100 has been retained in an active state across key cycles, without divesting from the context of this disclosure.

To provide an enhanced level of detail, an example case will now be provided to illustrate the method and operations of the wiper control system 200. In this example, the occupant operates the vehicle 10 in a rain storm and positions the user control 20 to activate the wiper system 100 in one of the multiple active states available. As a result, the wipers 12, 16 function by sweeping across the windshield 14 and/or the rear window 18 to intermittently clear the rain from view. When the occupant has completed the drive, the occupant places the vehicle 10 in park, turns the vehicle 10 off, and exits the vehicle 10. At this point, the occupant did not adjust the user control 20 and, as such, the user control 20 of the wiper system 100, remains in an active position such that if the vehicle 10 were in an ON state, one or both of the wipers 12, 16 would be active. In this example, when the vehicle 10 was placed in the OFF state, the wipers 12, 16 were in the resting position, between sweeps such that both wipers 12, 16 are hidden from view and fail to provide a visual indication that the wiper system 100 is still active.

When the occupant subsequently activates the vehicle 10 such that the vehicle 10 is in the ON state, the memory hardware 204 retains the previous state of the wipers 12, 16 (i.e., in the active state based on the position of the user control 20). However, upon startup, the visual notice 36 will appear on the display screen 26, which is visibly accessible by the occupant and will notify the occupant that the user control 20 is still active. In so doing, the wiper control system 200 notifies the occupant that the wipers 12, 16—while active based on the position of the user control 20 and/or the last state of the wipers 12, 16 during the previous drive—may no longer be needed in an effort to protect the wipers 12, 16 by preventing inadvertent operation of the wipers 12, 16 when unnecessary (i.e., during dry conditions).

The visual notice 36 states that the windshield wiper system is in an active state. Combined with the visual notice 36 is a functional suspension of the windshield wipers 12, 16 by the wiper control system 200 maintaining the wiper motors 206 in an OFF or rest state, as previously described. This functional suspension disables the windshield wipers 12, 16 from sweeping for a calibrated amount of time, even though the wiper system 100 is in an active state. Included in the visual notice 36 is a countdown timer 40 that begins counting down from the calibrated amount of time that suspends the function of the wipers 12, 16. This countdown begins once the vehicle 10 is moved from the OFF state to the ON state, and the amount of time remaining in the countdown is displayed by the countdown timer 40 in the visual notice 36.

During this calibrated amount of time, the occupant has a visual indication that the wiper system 100 is active via the visual notice 36, thereby allotting time for the occupant to decide what action to take regarding the wiper system 100. The occupant may decide to do nothing, waiting for the countdown timer 40 to expire. Upon expiration of the countdown timer 40, the visual notice 36 will disappear and the wipers 12, 16 will once again function in accordance with the specific active state of the wiper system 100. Alternatively, the occupant may decide to adjust the state of the wiper system 100 via the user control 20 before the countdown timer 40 expires. If the state of the wiper system 100 is changed before the countdown timer 40 expires, whether the state is changed to a different active state or the inactive state, the countdown timer 40 is cancelled, the visual notice 36 disappears, and the function of the wipers 12, 16 is no longer suspended, thereby allowing the wipers 12, 16 to function in accordance with the current state of the wiper system 100. Alternatively and optionally, the visual notice 36 may provide the occupant with a resume button 42. The resume button 42 may be selected by the occupant via pressing the resume button 42 on the visual notice 36 if the display screen 26 provides touchscreen capabilities, or by pressing a separate button disposed at another location in the interior cabin 24, accessible by the occupant, that controls the resume button 42 of the visual notice 36. Once the resume button 42 is selected, the countdown timer 40 is cancelled, the visual notice 36 disappears, and the function of the wipers 12, 16 is no longer suspended, thereby allowing the wipers 12, 16 to function in accordance with the current state of the wiper system 100. Furthermore, the countdown timer 40 may be cancelled, before the countdown timer 40 expires, by shifting the vehicle 10 out of the park state. Once the vehicle 10 is shifted out of the park state, the countdown timer 40 is cancelled, the visual notice 36 disappears, and the function of the wipers 12, 16 is no longer suspended, thereby allowing the wipers 12, 16 to function in accordance with the current state of the wiper system 100.

As an option, the visual notice 36 may also offer a clearing button 44 that clears the visual notice 36 from appearing on the display screen 26, while retaining the functional suspension of the wipers 12, 16 until the calibrated amount of time that the wipers 12, 16 are disabled expires, until the vehicle 10 is shifted out of the park state, or until the state of the wiper system 100 is changed at the user control 20. If the visual notice 36 is on a display screen 26 that offers touchscreen capabilities, the clearing button 44 may be selected by pressing the button 44 on the display screen 26, whereas if the visual notice 36 is on a display screen 26 that does not offer touchscreen capabilities, the clearing button 44 may be selected by pressing a separate button disposed at different location in the interior cabin 24, accessible by the occupant, that controls the clearing button 44 of the visual notice 36.

Continuing with the example described above, the occupant may decide that the wiper system 100 should be in the inactive state, as the weather no longer requires the wiper system 100 to be active. The calibrated amount of time before the wipers 12, 16 function allows the occupant the ability to manipulate the user control 20 and place the wiper system 100 in the inactive state. In doing so, the wipers 12, 16 do not sweep across a dry windshield or rear window, which may produce an unpleasant noise, reduce the longevity of the wipers 12, 16, and streak the windshield 14 or rear window 18 with debris. The occupant can then begin the drive with the wiper system 100 in the inactive state, as the function of the wipers 12, 16 is deemed unnecessary due to the dry weather.

The wiper control system 200 applies when the vehicle 10 changes from the OFF state to an ON state or an accessory state. The wiper system 100 is able to operate in both states, meaning if the occupant does not turn the vehicle 10 to the ON state but, rather, the accessory state, the occupant will still be presented with the same visual notice 36 and functional suspension of the wipers 12, 16 as described above, the status of which will adhere to the same conditional requirements.

The wiper control system 200 may be offered with varying options that may differ between different vehicles or different user preferences, such as the resume button 42 and the clearing button 44 that were described above as options. In other examples, the wiper control system 200 may be entirely disabled via a feature selection option in the vehicle 10. Many vehicles offer the occupant a series of feature selection options to customize the vehicle to the occupant's desires, such as an option to control the tone of the radio, an option to change the interior lighting color, an option to control the automatic high-beam headlights, among many other options. Included in this list of options may be an option to enable or disable the wiper control system 200. If desired, the occupant may disable the wiper control system 200 entirely, eliminating it from activating in the vehicle 10. Another option may be to include the specific active state of the wiper system 100 in the visual notice 36. In other words, the visual notice 36 may include whether the front wipers 12, the rear wiper 16, or both wipers 12, 16, are active, as well as the speed and length of intermittence of the wipers 12, 16.

Optionally, the wiper control system 200 may not function if not enough time passes between key cycles. For example, if the wiper system 100 is in an active state, the occupant changes the state of the vehicle 10 to the OFF state, and then moves the vehicle 10 into the ON state within five (5) seconds, the wiper control system 200 is not necessary, as not enough time has passed for the occupant to forget the state of the wiper system 100. Also, not enough time has passed for the weather conditions to significantly change or for the vehicle 10 to dry, meaning the temporary functional suspension of the wipers 12, 16 is not necessary.

The wiper control system 200 may also be designed to function during remote starts of the vehicle 10 if the wiper system 100 was in an active state at the end of the previous key cycle. However, during remote starts, the countdown timer 40 will not begin until occupant presence is detected in the vehicle 10. Occupant presence may be detected once the occupant presses an ignition button after entering the vehicle 10 during a remote-start scenario. Once the ignition button is pressed, the visual notice 36 will appear and the countdown timer 40 will begin in the same manner as described in the above example.

With particular reference to FIG. 5, an example flowchart detailing operation of the wiper control system 200 is provided. At 300, the system 200 determines whether the vehicle 10 has moved from an OFF state to an ON state or an accessory (ACC) state. If so, the system 200 determines whether the front wiper 12 or the rear wiper 16 is in an active state at 302. If either wiper 12, 16 is not in an active state at 302, the system 200 determines that a delay in activating the wiper motors 206 is unnecessary and a visual notice 36 on the display screen 26 is unnecessary at 304. The system 200 then returns to 300 to continually check for a change in state of the vehicle 10.

If the front wiper 12 or the rear wiper 16 is in an active state at 302, the system 200 determines whether the front wiper 12 or the rear wiper 16 was in an active state at the end of the last key cycle (i.e., when the vehicle 10 was last moved from the ON or ACC state into the OFF state) at 306. The previous state of the wiper system 100 may be determined by receiving information from the memory hardware 204 at 308 as to the state of the wiper system 100 when the vehicle 10 was last operated in the ON state. If either wiper 12, 16 was not in the active state at 306, the system 200 returns to 304. If either wiper 12, 16 was in the active state at the end of the last key cycle at 306, the system 200 then determines if the vehicle 10 is in the park state at 310. If not, the system 200 resets the wiper delay timer at 312, resumes wiper operation, and cancels the visual notice 36 at 304. If the vehicle 10 is in the park state at 310, the system 200 determines whether the state of the wiper system 100 has changed at 314. If not, the system 200 returns to 312. If so, the system 200 determines if the wiper delay timer is less than the time calibration at 316. If not, the system 200 returns to 312. If so, the system 200 displays the visual notice 36 on the display screen 26 at 318, disables the operation of the wipers 12, 16 at 320, and increments the wiper delay timer at 322. Finally, the system 200 returns to 310 to continually determine the state of the vehicle 10 (i.e., whether the vehicle 10 is in the park state).

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
based on adjustment of a power mode of a vehicle from an ON state to an OFF state, and based on a current operation mode of a wiper system of the vehicle comprising an active state, storing the current operation mode of the wiper system;
based on the stored current operation mode comprising the active state, and responsive to adjustment of the power mode of the vehicle from the OFF state to the ON state, operating the wiper system in an inactive state and generating an notification to an occupant of the vehicle; and
based on the stored current operation mode being the active state, and responsive to passage of a threshold period of time after generating the notification to the occupant of the vehicle, operating the wiper system in the active state.

2. The method of claim 1, wherein the notification comprises a visual notification at a display of the vehicle.

3. The method of claim 2, wherein the visual notification comprises a countdown timer generated based on the threshold period of time.

4. The method of claim 1, wherein, based on the stored current operation mode being the active state, before passage of the threshold period of time, and responsive to a mode selector of the vehicle being adjusted from a park mode to a propulsion mode, operating the wiper system in the active state.

5. The method of claim 1, wherein, based on the stored current operation mode being the active state, before passage of the threshold period of time, and responsive to a user input, operating the wiper system in the active state.

6. The method of claim 5, wherein the user input comprises an input at a wiper mode selector.

7. The method of claim 5, wherein the user input comprises acknowledgement of the notification.

8. The method of claim 1, wherein, based on adjustment of the power mode of the vehicle from the OFF state to the ON state during a remote start operation, generating the notification to the occupant of the vehicle occurs responsive to determining presence of the occupant in the vehicle.

9. The method of claim 1, wherein the wiper system comprises a front wiper.

10. The method of claim 1, wherein the wiper system comprises a rear wiper.

11. A wiper system configured to execute a computer-implemented method on data processing hardware that causes the data processing hardware to perform operations comprising:
based on adjustment of a power mode of a vehicle from an ON state to an OFF state, and based on a current operation mode of the wiper system of the vehicle comprising an active state, storing the current operation mode of the wiper system;
based on the stored current operation mode comprising the active state, and responsive to adjustment of the power mode of the vehicle from the OFF state to the ON state, operating the wiper system in an inactive state and generating a notification to an occupant of the vehicle; and
based on the stored current operation mode being the active state, and responsive to passage of a threshold period of time after generating the notification to the occupant of the vehicle, operating the wiper system in the active state.

12. The wiper system of claim 11, wherein the wiper system operates in the active state based on the stored current operation mode being the active state and responsive to a mode selector of the vehicle being adjusted from a park mode to a propulsion mode before passage of the threshold period of time.

13. The wiper system of claim 11, wherein, responsive to a user input, the wiper system operates in the active state based on the stored current operation mode being the active state and before passage of the threshold period of time.

14. The wiper system of claim 13, wherein the user input comprises an input at a wiper mode selector.

15. The wiper system of claim 13, wherein the user input comprises acknowledgement of the notification.

16. A vehicle comprising:
a wiper system configured to execute a computer-implemented method on data processing hardware that causes the data processing hardware to perform operations comprising:
based on adjustment of a power mode of a vehicle from an ON state to an OFF state, and based on a current operation mode of the wiper system of the vehicle comprising an active state, storing the current operation mode of the wiper system;
based on the stored current operation mode comprising the active state, and responsive to adjustment of the power mode of the vehicle from the OFF state to the ON state, operating the wiper system in an inactive state and generating a notification to an occupant of the vehicle; and
based on the stored current operation mode being the active state, and responsive to passage of a threshold period of time after generating the notification to the occupant of the vehicle, operating the wiper system in the active state.

17. The vehicle of claim 16, wherein the wiper system operates in the active state based on the stored current operation mode being the active state and responsive to a mode selector of the vehicle being adjusted from a park mode to a propulsion mode before passage of the threshold period of time.

18. The vehicle of claim 16, wherein, responsive to a user input, the wiper system operates in the active state based on the stored current operation mode being the active state and before passage of the threshold period of time.

19. The vehicle of claim 18, wherein the user input comprises an input at a wiper mode selector.

20. The vehicle of claim 18, wherein the user input comprises acknowledgement of the notification.
